(19) United States
(12) Patent Application Publication
(10) Pub. No.: US 2019/0292490 A1
(43) Pub. Date: Sep. 26, 2019

(54) PROCESS OF MAKING LIQUID HOUSEHOLD CARE COMPOSITIONS

(71) Applicant: The Procter & Gamble Company, Cincinnati, OH (US)

(72) Inventors: Douglas James WILDEMUTH, Cincinnati, OH (US); Jeffrey Frank OMNITZ, Cincinnati, OH (US); Scott William CAPECI, North Bend, OH (US); Sarah Ann DELANEY, Hebron, KY (US)

(21) Appl. No.: 15/928,176

(22) Filed: Mar. 22, 2018

(51) Int. Cl. C11D 1/37; C11D 3/20; C11D 3/37; C11D 3/04; C11D 3/33

(52) U.S. Cl. CPC C11D 1/37; C11D 3/201; C11D 3/3723; C11D 1/29; C11D 3/046; C11D 3/044; C11D 3/33; C11D 3/2086

(57) ABSTRACT

Processes of making liquid household care compositions, wherein input materials include liquid base compositions that are characterized as having a relatively low Reserve Alkalinity.

### FIELD OF THE INVENTION

The present disclosure relates to processes of making liquid household care compositions.

### BACKGROUND OF THE INVENTION

Manufacturers of consumer products typically make a variety of compositions to suit different consumer needs or desires. The variety of compositions may even be within a particular product category, such as laundry detergents or dish care products. The products are differentiated in one or more ways, such as surfactant level, surfactant type, adjuncts added, aesthetics, pH, etc. The products may be produced from one ore more base compositions, to which additional ingredients, including benefit agents, stabilizers, and the like, may be added.

Traditionally, such base compositions are buffered to a particular pH for stability and quality assurance reasons. Typical buffering agents include citric acid and/or salts thereof, fatty acids and/or salts thereof, and carbonate salts.

To save on capital and space, it may be desirable to produce the different products using shared manufacturing equipment. However, making a first product can leave residue on the manufacturing system that contaminates a second product. This can be particularly challenging when the base compositions comprise pH-adjusting materials, such as buffering agents. When such agents contaminate later-made products, it can be difficult to control the composition and pH of the later-made products with precision because the levels of residue are unpredictable, and the levels can change over time. The manufacturing equipment can be flushed between product runs, but the flushing step can take extra time and result in additional waste.

There is a need to improve processes for manufacturing a plurality of consumer product compositions, such as household care compositions, particularly on shared manufacturing equipment.

### SUMMARY OF THE INVENTION

The present disclosure relates to processes for manufacturing a plurality of liquid household care compositions.

For example, the process may include the steps of: (a) providing a first input material to a manufacturing system, the first input material comprising a first liquid base composition, the first liquid base composition comprising from about 1% to about 75%, by weight of the first liquid base composition, of a surfactant system, the first liquid base further being characterized by a Reserve Alkalinity of about 2.5% or less; (b) combining the first input material with a first pH-adjusting material to provide a first household care composition; (c) providing a second input material to the manufacturing line, the second input material comprising the first liquid base composition, a second liquid base composition, or mixtures thereof, the second liquid base composition comprising from about 1% to about 75%, by weight of the second liquid base composition, of a surfactant system, the second liquid base further being characterized by a Reserve Alkalinity of about 2.5% or less; (d) combining the second input material with the first pH-adjusting material, a second pH-adjusting material, or combinations thereof to provide a second household care composition, wherein the combination of steps (a) and (b) is not identical to the combination of steps (c) and (d).

### BRIEF DESCRIPTION OF THE DRAWINGS

The figures herein are illustrative in nature and are not intended to be limiting.

FIG. 1 shows a process according to the present disclosure, where a first liquid base composition is combined with a first pH-adjusting material.

FIG. 2 shows a process according to the present disclosure, where a first liquid base composition is combined with a second pH-adjusting material.

FIG. 3 shows a process according to the present disclosure, wherein a first liquid base composition is combined with a first pH-adjusting material.

FIG. 4 shows a process according to the present disclosure, wherein a second liquid base composition is combined with a second pH-adjusting material.

FIG. 5 shows a process according to the present disclosure, wherein a first liquid base composition and a third liquid base composition are combined with a first pH-adjusting material and a second pH-adjusting material.

FIG. 6 shows a process according to the present disclosure, wherein a first liquid base composition and a third liquid base composition are combined with a first pH-adjusting material and a second pH-adjusting material.

### DETAILED DESCRIPTION OF THE INVENTION

The present disclosure relates to processes of making a plurality of liquid consumer products, such as liquid household care compositions, on a shared manufacturing system. The processes relate to first formulating compatible base liquids, for example at similar pHs with limited buffering, and then combining the base (or bases) of choice together in a second stage process with a pH-adjusting material of choice. By selecting the types, quantities, and combinations of bases and pH-adjusting materials, as well as the additional adjuncts to be added, a variety of compositions can be efficiently made on the manufacturing system.

The starting liquid base compositions may be characterized by relatively low buffering capacity and/or relatively low Reserve Alkalinity (“RA”). Adjusting the pH of the input material relatively late in the process provides more manufacturing flexibility, and when the base material has a low RA, less pH-adjusting material will typically be required to tune the composition to the desired pH. Also, because the pH-adjusting material is added relatively late in the process, less of the manufacturing system is contaminated with the material, resulting in relatively less flushing and/or more predictable manufacturing. Finally, providing low RA base compositions can improve their compatibility with each other, so that more combinations of bases may be easily made, resulting in a greater variety of final products.

Furthermore, it may be desirable to formulate the base compositions at different pHs than the final product compositions, for example for stability purposes. However, adjusting the pH of the base compositions, when buffered, takes more material and can be less predictable. Without wishing to be bound by theory, formulating the base compositions to have a relatively low RA provides improved stability during storage and ease of pH adjustment during the product-making process.

The processes and compositions of the present disclosure are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein, the phrase “surface care composition” means a composition suitable for treating a surface. Suitable surfaces to be treated may include textiles such as fabrics, including articles to be laundered; hard surfaces such as dishware (including glassware and flatware), countertops, tile and other hard flooring, and bathroom fixtures such as sinks, toilets, and bathtubs/showers; hair; and skin. Surface care compositions may include fabric care compositions, dish care compositions, hard surface cleaning compositions, hair care compositions, skin care compositions, or mixtures thereof.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

As used herein, “Reserve Alkalinity” refers to the mass fraction of sodium hydroxide equivalent to the number of moles required to titrate a bulk solution from pH 11 to pH 3 using a strong acid, as determined according to method described in the Test Method section below. Without wishing to be limited by theory, the Reserve Alkalinity measurement is found to be the best measure of the alkalizing power of a composition, or the ability of a composition to provide a target alkaline wash pH when added at high dilution into tap water as opposed to pure or distilled water.

As used herein, “pH” is determined according to the method described in the Test Method section.

As used herein, the term “pH-adjusting material” is a material added to a composition that results in a changed and/or buffered pH of the resulting mixture. A pH-adjusting material may comprise a buffering agent, which may include a weak acid or a weak base. A pH-adjusting material, as used herein, may include a mixture of compounds. The term is not intended to include anionic surfactants, whether in acid or salt form.

As used herein, “compositionally different” means that the respective chemical makeups of at least two compositions are not identical, which may be due to different materials being added and/or different amounts of the same materials being added (including a material being added to one but not the other).

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Method of Making

The present disclosure relates to a process of making a plurality of liquid compositions, such as liquid household care compositions. In general, the process may include the step of providing a liquid base composition to a manufacturing system, combining it with a pH-adjusting material, and forming a final product, such as a household care composition. Typically, the liquid base compositions are characterized by a relatively low Reserve Alkalinity, such as about 2.5% or less. One or more of the liquid base compositions may include a surfactant system present at a level of from about 1% to about 75%, by weight of the liquid base composition.

A plurality of liquid base compositions may be provided, and one or more pH-adjusting materials may be provided. By selecting different combinations and/or levels of liquid base compositions and pH-adjusting materials, a plurality of final products can be effectively made on a shared manufacturing system.

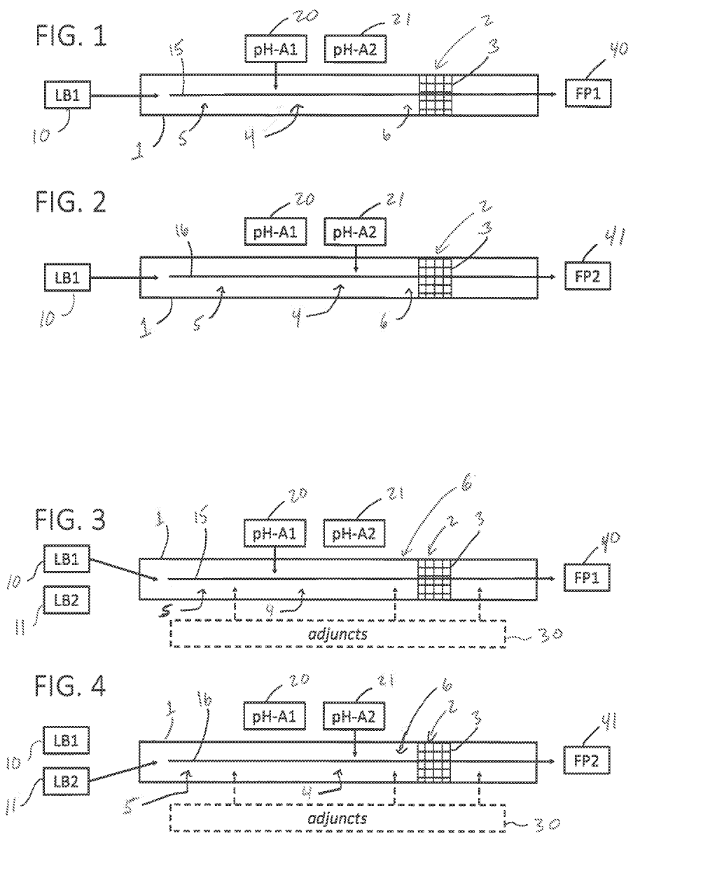

As shown schematically in FIG. 1, the process may include providing a first liquid base composition 10 (“LB”=liquid base). The first liquid base composition 10 may be part of a first input material 15 that is provided to a manufacturing system 1. The first input material 15 may be combined with a first pH-adjusting material 20 (“pH-A”=pH-adjusting material), for example in a confluence zone 4. The manufacturing system 1 may include a mixing zone 2, where the first input material 10 and the first pH-adjusting material 20 may be mixed more thoroughly. At any suitable point, adjunct ingredients 30 may be added to the manufacturing system 1. A first final product (“FP”=final product), such as a first household care composition 40, may be formed.

As shown schematically in FIG. 2, the process may include providing a second input material 16 to the manufacturing system 1. The second input material 16 may include the first liquid base composition 10. The second input material 16 may be combined with a second pH-adjusting material 21, and adjunct ingredients 30 may be added at any suitable point. A second final product, such as a second household care composition 41, may be formed.

The manufacturing systems 1 of the present disclosure may include any system suitable for making a desired final product. The processes of the present disclosure are suitable for making a plurality of products on shared manufacturing equipment. The manufacturing system 1 may include a closed central pipe, a mixing vessel such as a batch tank, a conveyor system, or combinations thereof. The first input material 15 may be provided to a first container on the manufacturing system 1, and the second input material 16 may be provided to a second container on the manufacturing system 1. The containers may be moveable as part of the manufacturing system, for example, conveyed on a conveyor system and/or independently moveable on different paths. The containers may be suitable for sale to individual consumers; for example, the containers may have a volume of from about 0.5 L to about 10 L.

As shown schematically in FIGS. 3 and 4, the process may include providing a first input material 15, which may include a first liquid base composition 10, to a manufacturing system 1. The first input material 15 may be combined with a first pH-adjusting material 20, forming a first final product, such as a first household care composition 40. The process may further include providing a second input material 16, which may include a second liquid base composition 11, to the same manufacturing system 1. The second input material 16 may be combined with a second pH-adjusting material 21, forming a second final product, such as a second household care composition 41.

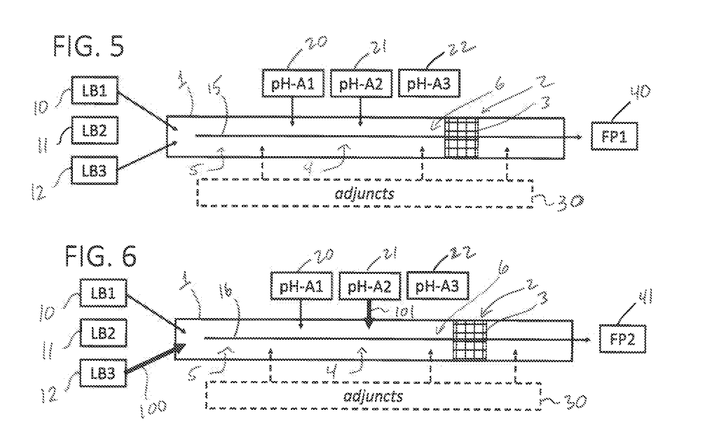

More than one liquid base composition and/or more than one pH-adjusting material may be added to the manufacturing system when forming a final product. For example, as shown schematically in FIG. 5, the first input material 15 may include a first liquid base composition 10 and a third liquid base composition 12. The first input material 15 is combined with a first pH-adjusting material 20 and a second pH-adjusting material 21. The process results in a final product, such as a first household care composition 40. A third liquid base composition 12 may be part of the first input 15 and/or the second input 16. A third liquid base composition 12 may be combined with the first liquid base composition 10 and/or the second liquid base composition 11. A third pH-adjusting material 22 may be added to the first and/or second input material 15, 16.

In the processes of the present disclosure, similar materials may be combined in different ratios and/or amounts to form different products. For example, FIG. 6 schematically shows a process similar to that of FIG. 5, where a first liquid base composition 10 and a third liquid base composition 12 are combined to form an input material (in FIG. 6, a second input material 16), which is combined with a first and second pH-adjusting material 21, 22. However, compared to the process of FIG. 5, relatively greater amounts of the third liquid base composition 12 and the second pH-adjusting material 21 (represented by heavier arrows 100, 101) are added to the system 1, and a second household care composition 41, which is different than the first household care composition 40, is formed.

The processes may comprise the step of adding adjunct ingredients 30 at any suitable point of the processes described herein. For example, adjunct ingredients 30 may be added before, during, and/or after a first pH-adjusting material 20 is added to the first input material 15. Adjuncts may be added before, during, and/or after a pH-adjusting material is added to the second input material 16.

Although a limited number of liquid base compositions 10, 11, 12, pH-adjusting materials 20, 21, 22, and combinations thereof are shown in the figures, the processes of the present disclosure can include any suitable number and variety of either. Although not intended to be limiting, additional combinations are discussed in the Examples section below.

The plurality of household care compositions, for example a first household care composition 40 and a second household care composition 41, may independently be liquid surface care compositions, such as fabric care compositions, dish care compositions, hard surface cleaner compositions, hair care compositions, skin care compositions, or mixtures thereof. The liquid detergent compositions of the present disclosure may be fabric care compositions, dish care compositions, or mixtures thereof, preferably fabric care compositions, more preferably a heavy duty liquid laundry detergent. The dish care compositions may be dish care compositions suitable for hand-washing and/or for washing in an automatic dishwasher.

The steps and compositions of the present processes are described in more detail below.

### Base Composition

The present processes may include the step of providing one or more liquid base compositions, such as a first, second, and/or third liquid base composition 10, 11, 12. The components of the liquid base compositions are suitable for inclusion in the final products, such as final household care composition(s).

The liquid base compositions may be provided as any suitable volume for the amount of resulting household care composition that is desired. For example, the volume may be sufficient to fill a single bottle (e.g., 1 liter) or sufficient to run a manufacturing system 1 at full capacity for one or more days (e.g., 1000s of liters or more).

The liquid base compositions may be characterized by a pH, determined according to the test method provided below. The liquid base compositions may independently be characterized by a basic pH, for example a pH of at least about 7.5. The base compositions, for example, the first liquid base composition and/or the second liquid base composition, may be characterized by a pH of at least about 9, or from about 9 to about 13, or from about 10 to about 13, or from about 11 to about 13, or from about 11 to about 12. Liquid base compositions having relatively high pH may be preferred for stability reasons. For example, such compositions may not require additional preservatives.

The liquid base compositions may be characterized by a relatively low Reserve Alkalinity (“RA”) value, as determined in the Test Method section provided below. The liquid base composition may be characterized by an RA value of about 2.5% or less, or from about 0.1%, or from about 0.2%, to about 2.5%, or to about 2.25%, or to about 2.0%, or to about 1.5%, or to about 1.0%, or to about 0.8%, or to about 0.6%.

The liquid base compositions may be substantially unbuffered. The liquid base composition may be substantially free of buffering agents, such as citric acid, acetic acid, lactic acid, a borate derivative, fatty acid, alkanolamine (such as monoethanolamine or triethanolamine), a caustic hydroxide compound (e.g., NaOH), a carbonate, a zeolite, or mixtures thereof. As used herein, the liquid base compositions may be substantially free of buffering agents, other than compounds present in amounts necessary to neutralize acid-forms of the present surfactants.

The liquid base compositions may include a surfactant system, which may comprise detersive surfactant. The base compositions may include from about 1%, or from about 5%, or from about 10%, or from about 15%, or from about 20%, and optionally up to about 75%, or up to about 60%, or up to about 50%, or up to about 40%, by weight of the base composition, of a surfactant system.

The detersive surfactant may be selected from anionic surfactants, nonionic surfactants, cationic surfactants, zwitterionic surfactants, amphoteric surfactants, ampholytic surfactants, and mixtures thereof. Those of ordinary skill in the art will understand that a detersive surfactant encompasses any surfactant or mixture of surfactants that provide cleaning, stain removing, or laundering benefit to soiled material. As used herein, fatty acids and their salts are understood to be part of the surfactant system, although such materials may also be used as pH-adjusting materials.

The detersive surfactant may include anionic surfactant. Anionic surfactant may be present in the largest proportion of all the surfactants present in the base composition. Non-limiting examples of suitable anionic surfactants include any conventional anionic surfactant. This may include a sulfate detersive surfactant, for e.g., alkoxylated and/or non-alkoxylated alkyl sulfate materials, and/or sulfonic detersive surfactants, e.g., alkyl benzene sulfonates. Suitable anionic surfactants may be derived from renewable resources, waste, petroleum, or mixtures thereof. Suitable anionic surfactants may be linear, partially branched, branched, or mixtures thereof.

The anionic surfactants may exist in an acid form, and the acid form may be neutralized to form a surfactant salt. Typical agents for neutralization include metal counterion bases, such as hydroxides, e.g., NaOH or KOH. Further suitable agents for neutralizing anionic surfactants in their acid forms include ammonia, amines, or alkanolamines. Non-limiting examples of alkanolamines include monoethanolamine, diethanolamine, triethanolamine, and other linear or branched alkanolamines known in the art; suitable alkanolamines include 2-amino- 1-propanol, 1-aminopropanol, monoisopropanolamine, or 1-amino-3-propanol. Amine neutralization may be done to a full or partial extent, e.g., part of the anionic surfactant mix may be neutralized with sodium or potassium and part of the anionic surfactant mix may be neutralized with amines or alkanolamines.

The detersive surfactant may include nonionic surfactant. Suitable nonionic surfactants include alkoxylated fatty alcohols. The nonionic surfactant may be selected from ethoxylated alcohols and ethoxylated alkyl phenols of the formula R(OC₂H₄)ₙOH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15.

Other non-limiting examples of nonionic surfactants useful herein include: C₈-C₁₈ alkyl ethoxylates, such as, NEODOL® nonionic surfactants from Shell; C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄—C₂₂ mid-chain branched alcohols, BA; C₁₄—C₂₂ mid-chain branched alkyl alkoxylates, BAEₓ, wherein x is from 1 to 30; alkylpolysaccharides; specifically alkylpolyglycosides; polyhydroxy fatty acid amides; and ether capped poly(oxyalkylated) alcohol surfactants.

The detersive surfactant may include a cationic surfactant. Non-limiting examples of cationic surfactants include: the quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; cationic ester surfactants; and amino surfactants, e.g., amido propyldimethyl amine (APA). Suitable cationic detersive surfactants also include alkyl pyridinium compounds, alkyl quaternary ammonium compounds, alkyl quaternary phosphonium compounds, alkyl ternary sulphonium compounds, and mixtures thereof. Suitable cationic detersive surfactants are mono-C₆₋₁₈ alkyl mono-hydroxyethyl di-methyl quaternary ammonium chlorides. Highly suitable cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

The detersive surfactant may include a zwitterionic surfactant. Examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. Suitable examples of zwitterionic surfactants include betaines, including alkyl dimethyl betaine and cocodimethyl amidopropyl betaine, C₈ to C₁₈ (for example from C₁₂ to C₁₈) amine oxides, and sulfo and hydroxy betaines, such as N-alkyl-N,N-dimethylammino-1-propane sulfonate where the alkyl group can be C₈ to C₁₈. Suitable amine oxides may include alkyl dimethyl amine oxide or alkyl amido propyl dimethyl amine oxide, more preferably alkyl dimethyl amine oxide and especially coco dimethyl amino oxide.

The detersive surfactant may include an amphoteric surfactant. Examples of amphoteric surfactants include aliphatic derivatives of secondary or tertiary amines, or aliphatic derivatives of heterocyclic secondary and tertiary amines in which the aliphatic radical may be straight or branched-chain and where one of the aliphatic substituents contains at least about 8 carbon atoms, or from about 8 to about 18 carbon atoms, and at least one of the aliphatic substituents contains an anionic water-solubilizing group, e.g. carboxy, sulfonate, sulfate. Suitable amphoteric surfactants also include sarcosinates, glycinates, taurinates, and mixtures thereof.

The surfactant systems of the first and second liquid base compositions independently comprise a detersive surfactant comprising anionic surfactant, nonionic surfactant, zwitterionic surfactant, or mixtures thereof. At least one of the following may be true: (a) the anionic surfactant is selected from linear and/or branched alkoxylated alkyl sulfate, linear and/or branched alkyl benzene sulphonate, or mixtures thereof; (b) the nonionic surfactant comprises ethoxylated alcohol; and/or (c) the zwitterionic surfactant comprises amine oxide. More than one, or even all, of (a), (b), and (c) may be true.

At least one of the surfactant systems of the first and/or second liquid base compositions may comprise anionic alkoxylated alkyl sulfate, such as alkyl ethoxylated sulfate (AES), as a major surfactant component. At least one of the surfactant systems of the first and/or second liquid base compositions may comprise anionic alkyl benzene sulfonate, such as linear alkyl benzene sulfonate (LAS), as a major surfactant component. The surfactant system of the first liquid base composition may comprise anionic alkoxylated alkyl sulfate (e.g., AES) as a major surfactant component, and the surfactant system of the second liquid base composition may comprise anionic alkyl benzene sulfonate (e.g., LAS) as a major surfactant component. As used herein, “major surfactant component” means the surfactant that is present in the surfactant system at the greatest quantity by weight relative to the other surfactants present. The major surfactant component is not necessarily present as a majority (e.g., more than 50wt %).

The liquid base compositions may include other ingredients, such as water, nonaminofunctional solvent, polymers, and/or additional adjunct ingredients.

The liquid base composition may comprise water, for example from about 10%, or from about 20%, or from about 25%, or from about 35%, or from about 40%, or from about 50%, to about 80%, or to about 75%, or to about 70%, or to about 60%, or to about 50%, by weight of the liquid base composition, of water. The liquid base composition may include greater than 25% water, or from about 25% to about 50% water, or from about 50% to about 70% water.

The liquid base compositions may comprise non-aminofunctional organic solvent. As used herein, “non-aminofunctional organic solvent” refers to any suitable organic solvent which contains no amino functional groups. Suitable non-aminofunctional organic solvents may include monohydric alcohols, dihydiic alcohols, polyhydric alcohols, glycerol, glycols, polyalkylene glycols such as polyethylene glycol, and mixtures thereof. The compositions of the present disclosure may include mixtures of solvents, such as mixtures of two or more of the following: lower aliphatic alcohols such as ethanol, propanol, butanol, isopropanol: diols such as 1,2-propanediol or 1,3-propanediol; and glycerol. The compositions of the present disclosure may include solvents that include propanediols but not methanol and/or ethanol. The non-aminofunctional organic solvents may be liquid at ambient temperature and pressure (i.e. 21° C. and 1 atmosphere), and may comprise carbon, hydrogen and oxygen. Non-aminofunctional organic solvents may also be added as adjunct ingredients according to the present processes.

The liquid base compositions may include polymers, such as alkoxylated polyethylenimine (PEI) polymers. Such polymers can provide performance benefits in the final product compositions, but also may provide solvent-like benefits in the liquid base compositions. Suitable polymers include PEI600 EO20 (ex BASF).

The liquid base compositions may include additional adjunct ingredients, as described below. The liquid base compositions may be substantially free of buffering agents (other than agents used to neutralized surfactants), enzymes, perfumes, encapsulated benefit agents, aesthetic dyes, hueing dyes, brighteners, opacifiers, or mixtures thereof, as being free of such material(s) may facilitate stability of the liquid base compositions and/or formulation flexibility of the final products.

The liquid base compositions may be partially or completely prepared and stored prior to beginning the present processes of making a plurality of detergents. For example, the liquid base compositions may be stored, e.g. in a storage tank, for at least six hours, or at least twelve hours, or at least eighteen hours, or at least twenty-four hours prior to the step of being combined with the first and/or second buffer compositions. The liquid base compositions may be made during an in-line process prior to combining the base composition(s) with the pH-adjusting composition(s). The liquid base compositions may be stored and then later modified by adding adjunct ingredients, prior to combining the base composition(s) with the pH-adjusting composition(s).

The liquid base compositions may be stored in a storage tank and then transported, e.g., by pumping through one or more pipes, to a manufacturing system 1 where the base composition will be combined with the buffering composition(s). First and second quantities of a first and/or second liquid base composition 10, 11 may travel the same path (e.g., a pipe) to where they are combined with first and second pH-adjusting materials 20, 21, respectively; see, e.g., FIGS. 1 and 2.

pH-Adjusting Materials

The present processes may include the step of adding one or more pH-adjusting materials to an input material, which may comprise one or more liquid base compositions.

The present processes may include the step of combining a first input material 15 with a first pH-adjusting material 20. The first pH-adjusting material 20 may comprise a first buffering agent. The first buffering agent may be suitable for buffering a composition at an acidic pH or at a basic pH, depending on the desired pH of the first household care composition 40.

The present processes may include the step of combining a second input material 16 with the first pH-adjusting material 20, a second pH-adjusting material 21, or combinations thereof. The second pH-adjusting material composition 21 may comprise a second buffering agent. The second buffering agent may be suitable for buffering a composition at an acidic pH or at a basic pH, depending on the desired pH of the second household care composition 41.

The first and/or second buffering agents may be selected from the group consisting of: non-surfactant organic acids; a borate compound; fatty acid; alkanolamine; a caustic hydroxide compound; a carbonate; a zeolite; or a mixture thereof.

Suitable non-surfactant organic acids may include citric acid, acetic acid, and/or lactic acid.

As used herein, a “borate compound” is a compound that comprises borate or that is capable of providing borate in solution. The borate compound may be any compound that is suitable for inclusion in a desired product composition. Borate compounds may include boric acid, boric acid derivatives, boronic acid, boronic acid derivatives, and combinations thereof. Boric acid derivatives include boron-containing compounds where at least a portion of the compound is present in solution as boric acid or a chemical equivalent thereof. Suitable boric acid derivatives include MEA-borate (i.e., monoethanolamine borate), borax, boric oxide, tetraborate decahydrate, tetraborate pentahydrate, alkali metal borates (such as sodium ortho-, meta- and pyroborate and sodium pentaborate), and mixtures thereof. Suitable boronic acids may include phenylboronic acid, ethylboronic acid, 3-nitrobenzeneboronic acid, or mixtures thereof.

Suitable fatty acids may include fatty acids having from about 10 to about 22 carbon atoms. Suitable fatty acids are saturated or unsaturated and can be obtained from natural sources such as, for example, plant or animal esters (e.g. palm oil, coconut oil, babassu oil, safflower oil, tall oil, castor oil, tallow and fish oils, grease, and mixtures thereof) or can be synthetically prepared for example via the oxidation of petroleum or by hydrogenation of carbon monooxide via the Fisher-Tropsch process. Examples of suitable saturated fatty acids for use in the compositions of the present disclosure may include capric, lauric, myristic, palmitic, stearic, arachidic and/or behenic acid. Suitable unsaturated fatty acid species may include: palmitoleic, oleic, linoleic, linolenic and/or ricinoleic acid. The fatty acid may comprise a mixture of fatty acids.

Suitable alkanolamines may include monoethanolamine (MEA), diethanolamine, triethanolamine (TEA), or mixtures thereof.

Suitable caustic hydroxide compounds may include alkali metal hydroxides, alkaline earth metal hydroxides, ammonium hydroxides, or mixtures thereof. The caustic hydroxide compounds may include sodium hydroxide, potassium hydroxide, or mixtures thereof. Caustic hydroxide compounds may be preferred for compositions that are intended to have relatively low buffering capacity.

Suitable carbonates may include alkali metal carbonates, alkaline earth metal carbonates, ammonium carbonates, or mixtures thereof. The carbonate may include sodium carbonate, potassium carbonate, magnesium carbonate, calcium carbonate, or ammonium carbonate.

The first and second buffering agents may be different from each other. One of the first and second buffering agents (e.g., the first) may be suitable for buffering a composition to an acidic pH, and the other of the first and second buffering agents (e.g., the second) may be suitable for buffering a composition to a basic pH. One of the first and second buffering agents may be selected from the group consisting of citric acid, acetic acid, lactic acid, or mixture thereof, and the other of the first and second buffering agents may be selected from the group consisting of a borate compound, an alkanolamine (such as MEA), fatty acid, or a mixture thereof.

The first pH-adjusting material 20 may be combined with the first input material 15 in an amount suitable to buffer the resulting mixture to the desired pH. For example, from about 1 part to about 25 parts by weight of the first pH-adjusting material 20 may be combined with about 100 parts by weight of the first input material 15. A sufficient amount of the first pH-adjusting material 20 may be combined with the first input material 20 to provide in the first household care composition 40 from about 1% to about 25%, by weight of the first household care composition 40, of the first buffering agent in the first household care composition 40.

The second pH-adjusting material 21 may be combined with a second input material 16 in an amount suitable to buffer the resulting mixture to the desired pH. For example, from about 1 part to about 25 parts of the second pH-adjusting material 21 may be combined with about 100 parts of the second input material 16. A sufficient amount of the second pH-adjusting material 21 may be combined with the second input material 16 to provide in the second household care composition 41 from about 1% to about 25%, by weight of the second household care composition 41, of the second buffering agent in the second household care composition 41.

The relative amount of pH-adjusting material added will depend, for example, on the RA value of the base compositions and/or the input materials, the buffering agent used, and the desired end pH of the resulting household care composition. Table 1 provides exemplary buffering agents and estimated amounts to be added to a particular base composition in order to achieve a particular target pH in the final composition.

TABLE 1

| | Exemplary | Estimated |
|---|---|---|
| Target Final pH | Buffering Agents | Levels* |
| 2.5 | Citric Acid | 3-20% |
| (well-buffered) | Acetic Acid | |
| | Lactic Acid | |
| 6 | Citric Acid | 1-7% |
| | Acetic Acid | |
| | Lactic Acid | |
| 8-9 | Boric Acid | 1-10% |
| | Fatty Acid | |
| 10 | NaOH/MEA | 2-5% |
| (low-buffered | | |
| composition) | | |
| 10 | NaCarbonate | 5-10% |
| (well-buffered | | |
| composition) | | |

*estimated amount added to a liquid base composition having an RA value of about 0.5 and an initial pH of about 11, measured as % active of buffering agent (including both acid and salt forms), by weight of the final composition

The pH-adjusting materials may comprise additional adjuncts in addition to buffering agents. For example, the pH-adjusting materials may comprise surfactants, organic solvents, polymers, stabilizers, water, and mixtures thereof.

The first and second pH-adjusting materials 20, 21 may be combined with the first and second input materials 15, 16, respectively, in any suitable manner. For example, one or both combining steps may be performed as part of a batch process, e.g. combined in a batch tank. One or both combination steps may be performed as part of a continuous in-line process.

The combination steps may be part of a continuous in-line process. A first input material 15, which may comprise a first liquid base composition 10, may be transported, e.g., pumped through a pipe, to a confluence zone 4 from a region 5 that is upstream of the confluence zone 4. The first input material 15 may be combined with the first pH-adjusting material 20 in the confluence zone 4, resulting in a first household care composition 40 in a region 6 downstream of the confluence zone 4. A second input material 16, which may include a first and/or second liquid base composition 10, 11, may be transported, e.g., pumped through a pipe, to a confluence zone 4 from a region 5 that is upstream of the confluence zone 5; the confluence zone of this step may be the same or different (e.g., a second confluence zone) as the confluence zone of the step where the first input material 15 and the pH-adjusting material are/were combined. The second input material 16 may be combined with the second pH-adjusting material 21 in the confluence zone 4, resulting in a second household care composition 41 in a region 6 downstream from the confluence zone 4.

The steps of combining the input materials with the pH-adjusting materials may generate thermal energy due to heats of neutralization. A benefit of the present processes is that by starting with a base composition having a low Reserve Alkalinity, the amount of energy generated by these combining steps will be relatively low. It is believed that because the base composition is relatively unbuffered, relatively few neutralization reactions occur during the process of adding the pH-adjusting material and/or bringing the mixture to the desired pH, and therefore, relatively low levels of energy are generated and released.

The input material, the pH-adjusting material, or both may be at ambient temperature when combined. The step of combining the input material and the pH-adjusting material may produce less than about 2° C. of temperature rise in the resulting bulk solution. It may be that an external heat exchanger is not required or desired to control temperature changes in the processes of the present disclosure.

Following the combining step, the resulting mixture of input material and pH-adjusting material may be mixed, for example with a static mixer 3. One or more mixing steps may occur in one or more mixing zones 2, which may be downstream of the confluence zone(s) 4. The mixing zone(s) 2 may include one or more static mixers 3. Adjunct ingredients 30 may be added upstream or downstream from the mixing zones 3.

As described above and shown schematically in FIGS. 1 and 2 and in FIGS. 3 and 4, the combining steps may occur on the same manufacturing system 1.

Although not shown, the present disclosure also contemplates providing the liquid base compositions and pH-adjusting materials to different manufacturing systems to form different final products. The low-RA liquid base compositions contribute to the flexibility of making compositions, even on different manufacturing systems. For example, a first input material 15 comprising a first liquid base composition 10 may be provided to a first manufacturing system and combined with a first pH-adjusting material 20 to provide a first household care composition 40, and a second input material 16 comprising the first liquid base composition 10, a second liquid base composition 11, or mixtures thereof may be provided to a second manufacturing system and combined with a same or different pH-adjusting material to provide a second household care composition 41. A first portion of a low-RA first liquid base composition may be combined with a first pH-adjusting material on a first manufacturing system to form a first household care composition, and a second portion of the first liquid base composition may be combined with a second pH-adjusting material on a second manufacturing system to form a second household care composition.

The manufacturing system 1 may be flushed by a fluid between the first combining step and the second combining step, and/or between the providing of the first input material 15 and the providing of the second input material 16. The fluid may be an aqueous fluid, such as water or an aqueous solution. The fluid used to flush the system may comprise a liquid base composition, preferably one that is present in the second input material. This way, the manufacturing system is flushed of the old input material and “primed” with the new input material. Typically, the fluid used to flush the system does not include the pH-adjusting materials and/or buffering agents described herein. Water can be useful and cost-efficient; in at least some circumstances, it may be less preferred, as residual water in the system may dilute later-made product, thereby affecting quality control.

At least a portion of the fluid used to flush the system may be captured and blended into one or more liquid base compositions that will be used to make household care compositions in later-in-time manufacturing operations, thereby reducing waste.

The combining steps may occur in different containers, which may be final product containers, such as a first bottle and a second bottle, respectively. The different containers may be provided on a conveyor system. The combining steps may occur in the same nozzle or different nozzles, such as in a first nozzle and a second nozzle, respectively. The containers may first receive the liquid base composition, or they may first receive the pH-adjusting material. The container may receive the liquid base composition and the pH-adjusting material at substantially the same time, for example by substantially simultaneous injection of at least two streams. Depending on the volumes dispensed and/or dispensing rates, the two or more streams may start and/or stop at non-simultaneous times.

The compositions in the containers (e.g., first and second bottles) may be mixed during or after combining, for example by shaking and/or rotating the containers/bottles. It is appreciated that the turbulence from the combining step may provide sufficient mixing, and/or that one of ordinary skill may adjust appropriate variables, e.g., the flow rate of the base compositions, the first and/or second pH-adjusting materials, and/or the household care composition into the bottle, to provide sufficient mixing.

### Final Compositions

The processes of the present disclosure are useful for making a plurality of liquid compositions, such as liquid consumer products, including household care compositions. Because of the flexibility provided by the disclosed processes, a relatively large number of products may be efficiently made from a relatively limited number of liquid base compositions. The plurality of liquid household care compositions made from the disclosed processes may comprise at least three, preferably at least four, more preferably at least five household care compositions for every liquid base composition used in the process.

The final products may be made, at least in part, by combining a first input material 15, which may contain a liquid base composition, with a pH-adjusting material. The step of combining the first input material 15 with the first pH-adjusting material 20 may result in a first liquid household care composition 40. The step of combining the second input material 16 with a pH-adjusting material may result in a second liquid household care composition 41.

The first and/or second liquid household care compositions 40, 41 may be surface care compositions, such as fabric care compositions, dish care compositions, hard surface cleaning compositions, hair care compositions, skin care compositions, or mixtures thereof. The first and/or second liquid household care compositions 40, 41 may be fabric care compositions, dish care compositions, or mixtures thereof. The liquid household care compositions may be fabric care compositions, such as a liquid laundry detergent.

The first liquid household care composition 40 and the second liquid household care composition 41 may each be independently characterized by a pH. The pH of the first liquid household care composition (i.e., a first pH) may be different from the pH of the second liquid household care composition (i.e., a second pH).

The first pH may be different from the second pH by at least about one pH unit. In other words:

|first pH−second pH|≥1

The first pH may be different from the second pH by at least about one, or at least about two, or at least about three, or at least about four, or at least about five pH units. The first pH may be different from the second pH by from about one, or from about two, or from about three, or from about four, to about ten, or to about eight, or to about six, or to about five.

The first and second pHs may both be basic (i.e., above 7). One of the first and second household care compositions may be characterized by an acidic pH, and the other of the first and the second household care compositions may be characterized by a basic pH. At least one of the first and second household care compositions may be characterized by a pH of from about 2, or from about 2.5 or from about 3, to about 6.5, or to about 6, or to about 5, or to about 4. At least one of the first and second household care compositions may be characterized by a pH of from about 7.5 to about 11, or to about 10, or to about 9, or to about 8.5.

The processes of the present disclosure may be particularly useful when it is desired to make a household care composition having an acidic pH. Compositions having low (acidic) pH may contribute to negative metallurgical effects on materials commonly used in manufacturing equipment, such as carbon steel and/or stainless steel. Because a pH-adjusting agent may be added to input materials relatively late in the present processes, low-pH compositions may be in contact with the equipment for relatively short periods of time and/or over relatively short distances. Thus, the negative effects may be minimized or more easily addressed.

The household care compositions of the present disclosure may be characterized by a Reserve Alkalinity. The RA of the household care composition may be greater than at least one liquid base composition, preferably greater than all of the liquid base compositions, that were used to prepare the household care composition. The RA of the household care composition may be greater than about 2.0%, or greater than about 2.5%, or greater than about 3%, or greater than about 4%, or greater than about 5%.

The first and/or second household care compositions 40, 41 of the present disclosure may include additional adjunct ingredients 30. These ingredients may be present in the liquid base compositions 10, 11, 12 as provided, or they may be added during the processes described herein. For example, adjunct ingredients 30 may be added before, during, or after the pH-adjusting material 20, 21, 22 has been combined with the base composition. FIGS. 3-6, for example, schematically show that adjunct ingredients 30 may be optionally added before or after the pH-adjusting materials are combined with the base composition.

The present processes may include adding different adjunct ingredients 30 to the different mixtures that will become the first and second household care compositions, respectively 40, 41. Adding different adjuncts is desirable to differentiate the products so that they provide different benefits and/or include different aesthetics. Additionally, when the pHs of the first and second household care compositions 40, 41 differ, the adjuncts may differ as well, at least in part. For example, certain adjuncts that are compatible (e.g., stable and/or effective) at the first pH may be added to the first household care composition 40, and other adjuncts that are compatible with the second pH may be added to the second household care composition 41. Enzymes are known to be pH-sensitive, and may be added to one composition but not both, or a first enzyme compatible with the first pH may be added to the first household care composition 40, and/or a second enzyme compatible with the second pH may be added to the second household care composition 41.

Any adjunct ingredient 30 suitable for the final form and intended end-use of the described household care compositions may be added at any suitable point of the present processes. The adjunct ingredients 30 may be added at a level suitable to provide a performance benefit. The adjunct ingredients 30 may be present, individually or collectively, in the compositions of the present disclosure at a level of from about 0.00001%, or from about 0.0001%, or from about 0.001%, or from about 0.01%, or from about 0.1%, or from about 1%, to about 50%, or to about 40%, or to about 30%, or to about 20%, or to about 15%, or to about 10%, or to about 8%, or to about 6%, or to about 5%, or to about 4%, or to about 3%, or to about 2%, or to about 1%, by weight of the composition. The adjunct ingredient 30 may be present at a level of from about 0.001% to about 10%, by weight of the composition.

The liquid household care compositions described herein may include one or more of the following non-limiting list of ingredients: fabric care benefit agent; detersive enzyme; deposition aid; rheology modifier; builder; chelant; bleach; bleaching agent; bleach precursor; bleach booster; bleach catalyst; neat perfume and/or encapsulated perfume; perfume loaded zeolite; starch encapsulated accord; polyglycerol esters; whitening agent; pearlescent agent; enzyme stabilizing systems; scavenging agents including fixing agents for anionic dyes, complexing agents for anionic surfactants, and mixtures thereof; optical brighteners or fluorescers; polymer including but not limited to soil release polymer and/or soil suspension polymer; dispersants; antifoam agents; non-aqueous solvent; fatty acid; suds suppressors, e.g., silicone suds suppressors; cationic starches; scum dispersants; substantive dyes; colorants; opacifier; antioxidant; hydrotropes such as toluenesulfonates, cumenesulfonates and naphthalenesulfonates; color speckles; colored beads, spheres or extrudates; clay softening agents; anti-bacterial agents.

Additionally or alternatively, the compositions may comprise surfactants, quaternary ammonium compounds, and/or solvent systems. Quaternary ammonium compounds may be present in fabric enhancer compositions, such as fabric softeners, and comprise quaternary ammonium cations that are positively charged polyatomic ions of the structure NR4+, where R is an alkyl group or an aryl group.

The compositions disclosed herein may comprise an adjunct selected from the group consisting of a structurant, a builder, an organic polymeric compound, an enzyme, an enzyme stabilizer, a bleach system, a brightener, a hueing agent, a chelating agent, a suds suppressor, a conditioning agent, a humectant, neat perfume, encapsulates (such as perfume encapsulates), a filler or carrier, and mixtures thereof. The compositions of the present disclosure may comprise an adjunct selected from encapsulates, neat perfume, enzymes, fabric hueing agents, conditioning agents, fabric enhancement polymers, pearlescent agents, opacifiers, or mixtures thereof.

The compositions of the present disclosure may further comprise a structurant or thickener which may be useful to maintain the non-homogeneity of the present compositions, e.g., by “locking” the components into place. Structurants may also be useful to maintain stability and/or to suspend benefit agents. Suitable structurants/thickeners may include non-polymeric crystalline hydroxyl-functional materials, such as a crystallizable glyceride (e.g., hydrogenated castor oil or derivatives thereof).

The processes of the present disclosure may include one or more finishing steps, in which certain adjunct ingredients are added, e.g., downstream from the confluence zone 4, after the base composition(s) has been combined with the first and/or second pH-adjusting material(s), to result in the final household care composition(s). For example, the finishing step may comprise adding aesthetic ingredients, such as neat perfume and/or aesthetic dye. The finishing step may include adding encapsulated benefit agents, such as perfume encapsulates; a structuring agent may be added before or after the encapsulated benefit agent is added, preferably after. The finishing step may comprise mixing the household care composition, for example, with a static mixer 3. The making processes of the present disclosure may include multiple mixing steps. The manufacturing systems 1 of the present disclosure may include more than one mixing zone 2, such as more than one static mixer 3.

The first and/or second household care compositions 40, 41 may include at least about 50%, or at least about 60%, or at least about 70%, or at least about 75%, or at least about 80%, by weight of the composition, of water.

The processes of the present disclosure may include a filling step. The filling step may include disposing at least a portion of the household care compositions in a container. The container may be a storage container, a transport container, or a container suitable for sale to a consumer, such as a bottle or bag. Multiple containers may be bundled for transport, such as multiple bottles in a box or on a pallet.

### Methods of Use

The household care compositions made by the present processes may be used for their intended end-use according to known methods. For example, fabric care compositions may be used to treat a fabric, for example by contacting a fabric with a wash liquor comprising water and a portion of the fabric care composition. Dish washing compositions may be used to treat, e.g., dirty dishes, glassware, and/or flatware by contacting the dishes, etc., with an aqueous mixture of water and the dish washing composition. Manual and automatic (e.g., with a suitable machine) treatment processes are contemplated by the present disclosure.

### Combinations

Specifically contemplated combinations of the disclosure are herein described in the following lettered paragraphs. These combinations are intended to be illustrative in nature and are not intended to be limiting.

A. A process for manufacturing a plurality of liquid household care compositions, the process comprising the steps of: (a) providing a first input material to a manufacturing system, the first input material comprising a first liquid base composition, the first liquid base composition comprising from about 1% to about 75%, by weight of the first liquid base composition, of a surfactant system, the first liquid base further being characterized by a Reserve Alkalinity of about 2.5% or less; (b) combining the first input material with a first pH-adjusting material to provide a first household care composition; (c) providing a second input material to the manufacturing system, the second input material comprising the first liquid base composition, a second liquid base composition, or mixtures thereof, the second liquid base composition comprising from about 1% to about 75%, by weight of the second liquid base composition, of a surfactant system, the second liquid base further being characterized by a Reserve Alkalinity of about 2.5% or less; (d) combining the second input material with the first pH-adjusting material, a second pH-adjusting material, or combinations thereof to provide a second household care composition; wherein the combination of steps (a) and (b) is not identical to the combination of steps (c) and (d).

B. A process for manufacturing a plurality of liquid household care compositions that have different pH values, the process comprising the steps of: (a) combining a first portion of a liquid base composition with a first buffer composition in a confluence zone, thereby resulting in a first liquid household care composition, wherein the liquid base composition comprises from about 1% to about 75% of detersive surfactant and is characterized by, prior to combination with the buffer combination, a Reserve Alkalinity of no more than about 2%; (b) combining a second portion of the liquid base composition with a second buffer composition, wherein the combining step of step (b) occurs in a confluence zone that is the same zone as or a different zone from the confluence zone of step (a), and wherein the combining step of step (b) results in a second liquid household care composition at a region downstream from the confluence zone of step (b); wherein the first and second household care compositions are characterized by pHs that are different by at least 2 pH units.

C. A process for manufacturing a plurality of household care compositions, the process comprising the steps of: (a) providing a plurality of liquid base detergent compositions, the plurality comprising at least a first liquid base composition and a second liquid base composition, the liquid base compositions of the plurality each comprising from about 1% to about 75%, by weight of the composition, of a surfactant system, and each being characterized by a Reserve Alkalinity of up to about 2%; (b) providing a plurality of pH-adjusting materials, the plurality comprising at least a first pH-adjusting material and a second pH-adjusting material; (c) providing a first input material to a manufacturing system, wherein the first input material comprises at least the first liquid base detergent composition; (d) combining the first input material with the first pH-adjusting material to provide a first household care composition; (e) providing a second input material to the manufacturing system, wherein the second input material comprises the first liquid base composition, the second liquid base composition, or combinations thereof; (f) combining the second input material with a member of the plurality of the pH-adjusting materials to provide a second household care composition that is compositionally different than the first household care composition, the member comprising the first pH-adjusting material, the second pH-adjusting material, or combinations thereof.

D. A process for manufacturing a plurality of household care compositions, the process comprising the steps of: (a) providing a first liquid base composition and optionally a second liquid base composition, wherein each of the liquid base compositions comprises from about 1% to about 75%, by weight of the composition, of a surfactant system, and wherein each of the liquid base compositions is characterized by a Reserve Alkalinity of up to about 2%; (b) providing a first pH-adjusting material and optionally a second pH-adjusting material; (c) selecting a liquid base composition from step (a) and combining it with a pH-adjusting material from step (b) on a manufacturing line to form a first household care product; (d) selecting a liquid base composition from step (a) and combining it with a pH-adjusting material from step (b) on the manufacturing line to form a second household care product that is compositionally different from the first household care product, wherein the liquid base composition and/or pH-adjusting material of step (d) are of different type(s) and/or present at different relative amount(s) than the liquid base composition and/or the pH-adjusting material of step (c).

E. A process for manufacturing a plurality of household care compositions, the process comprising the steps of: (a) combining a first input material and a first pH-adjusting material on a manufacturing system to form a first household care composition; (b) combining a second input material and a second pH-adjusting material on the manufacturing system to form a second household care composition that is different from the first household care composition; (c) wherein the first input material and the second input material each independently comprise a first liquid base composition, a second liquid base composition, or a mixture thereof, wherein the first liquid base composition and the second liquid base composition each independently comprise from about 1% to about 75%, by weight of the liquid base composition, of a surfactant system, wherein the first and second liquid base compositions are each independently characterized by a Reserve Alkalinity of no greater than about 2%, and wherein the first and second liquid base compositions may be the same or may be different; and wherein the first and second pH-adjusting material may be the same or different.

F. A process for manufacturing a plurality of liquid household care compositions that have different pH values, the process comprising the steps of: (a) providing a liquid base composition having a Reserve Alkalinity of about 2% or less, the base composition comprising from about 1% to about 75% of detersive surfactant; (b) combining a first buffer composition with a first quantity of the liquid base composition to provide a first liquid household care composition having a first pH; (c) combining a second buffer composition with a second quantity of the liquid base composition to provide a second liquid household care composition having a second pH, wherein the first pH is different from the second pH by at least about 1 pH unit.

G. A process according to any of paragraphs A-F, wherein the second input material comprises the first liquid base composition.

H. A process according to any of paragraphs A-G, wherein the second input material comprises the second liquid base composition.

I. A process according to any of paragraphs A-H, wherein the manufacturing system comprises a closed central pipe, a batch tank, a conveyor system, or combinations thereof.

J. A process according to any of paragraphs A-I, wherein the first input material is provided to a first container on the manufacturing system, and wherein the second input material is provided to a second container on the manufacturing system.

K. A process according to any of paragraphs A-J, wherein the manufacturing system is flushed with a composition between the providing of the first input material and the providing of the second input material, preferably flushed with a composition, more preferably with a liquid base composition, that is also present in the second input material.

L. A process according to any of paragraphs A-K, wherein the surfactant systems of the first and second liquid base compositions each independently comprise a detersive surfactant comprising anionic surfactant, nonionic surfactant, zwitterionic surfactant, or mixtures thereof.

M. A process according to any of paragraphs A-L, wherein at least one of the following is true: the anionic surfactant is selected from linear and/or branched alkoxylated alkyl sulfate, linear and/or branched alkyl benzene sulphonate, or mixtures thereof; and/or the nonionic surfactant comprises ethoxylated alcohol; and/or the zwitterionic surfactant comprises amine oxide.

N. A process according to any of paragraphs A-M, wherein at least one of the surfactant systems of the first and/or second liquid base compositions comprise anionic alkoxylated alkyl sulfate as a major surfactant component.

0. A process according to any of paragraphs A-N, wherein at least one of the surfactant systems of the first and/or second liquid base compositions comprise anionic alkyl benzene sulfonate as a major surfactant component.

P. A process according to any of paragraphs A-O, wherein the first and/or second liquid base compositions has a Reserve Alkalinity of from about 0.1% to about 2.25%, or to about 2.0%, or to about 1.5%, or to about 1.0%.

Q. A process according to any of paragraphs A-P, wherein the first pH-adjusting material and/or the second pH-adjusting material comprises a material independently selected from the group consisting of: a non-surfactant organic acids; a borate compound; a fatty acid; an alkanolamine; a caustic hydroxide compound; a carbonate; a zeolite; and mixtures thereof.

R. A process according to any of paragraphs A-Q, wherein: the first pH-adjusting material comprises a first buffering agent and is added to the first input material in an amount sufficient so that the first household care composition comprises from about 1% to about 25%, by weight of the first household care composition, of the first buffering agent; or the second pH-adjusting material comprises a second buffering agent and is added to the second input material in an amount sufficient so that the second household care composition comprises from about 1% to about 25%, by weight of the second household care composition, of the second buffering agent; or both.

S. A process according to any of paragraphs A-R, wherein the first liquid base composition and/or the second liquid base composition, preferably both, is characterized by a pH of at least about 9, or from about 9 to about 13, or from about 10 to about 13, or from about 11 to about 13, or from about 11 to about 12.

T. A process according to any of paragraphs A-S, wherein the first household care composition is characterized by a first pH, and the second household care composition is characterized by a second pH that is different from the first pH, preferably where the second pH is at least 1 pH unit different than the first pH.

U. A process according to any of paragraphs A-T, wherein: the first household care composition is characterized by a first pH that is about 7.5 or greater, preferably from about 7.5 to about 10, more preferably from about 7.5 to about 8.5; or the second household care composition is characterized by a second pH that is about 6.5 or less, preferably from about 2 to about 6.5, more preferably from about 2.5 to about 5; or both.

V. A process according to any of paragraphs A-U, wherein the process further comprises at least one additional step of adding one or more adjuncts independently to the first input material, the second input material, or both.

W. A process according to to any of paragraphs A-V, wherein the one or more adjuncts comprise a structurant, a builder, an organic polymeric compound, an enzyme, an enzyme stabilizer, a bleach system, a brightener, a hueing agent, a chelating agent, a suds suppressor, a conditioning agent, a humectant, neat perfume, perfume encapsulates, a filler or carrier, or mixtures thereof.

X. A process according to any of paragraphs A-W, wherein the first input material and/or the second input material further comprises a third liquid base composition, the third liquid base composition comprising from about 1% to about 75%, by weight of the second liquid base composition, of a surfactant system, the third liquid base composition further being characterized by a Reserve Alkalinity of up to about 2%, wherein the third liquid base composition is compositionally different from the first and second liquid base compositions.

Y. A process according to any of paragraphs A-X, wherein the first and second household care compositions are independently selected from a laundry detergent composition, a fabric pretreatment composition, a fabric softener composition, a dish care composition, or a combination thereof.

Z. A process according to any of paragraphs A-Y, wherein the plurality of liquid household care compositions made from the process comprises at least three, preferably at least four, more preferably at least five household care compositions for each liquid base composition used in the process.

TEST METHODS

### Reserve Alkalinity (“RA”)

The following method is used to determine the Reserve Alkalinity (“RA”) of a composition, for example a base composition according to the present disclosure.

First, provide a 5 g sample of base composition and dilute with 45 g DI water. The pH of this diluted composition is referred to as the “formulated pH” value. If the formulated pH is greater than 3, then this diluted composition is placed in an auto-titration device in which the solution pH is then adjusted with HCl (0.1N) in approximately 0.01 mL quantities until a pH value of 3 or less is measured in the diluted composition. The auto-titration results are tabulated to create a table of milliliters (and hence moles) of HCl added vs the resultant solution pH measured after each addition of HCl. The auto-titration data tabulated is used in the calculation below in order to determine the % equivalent of NaOH which would be required in the diluted composition in order to shift the pH from 3 to the formulated pH value.

$$\% {NaOH}_{down} = \frac{mls HCl * N . HCl * 40 * 100}{Sample wt ( g ) * 1000}$$

wherein:

mis HCl is the volume of HCl added to achieve a pH of 3, expressed in units of millilitres

N.HCl is the concentration of the HCl added, expressed in units of Normals

Sample wt (g) is the mass of the sample of undiluted base composition, in grams.

“40” represents the molar mass of NaOH (in g/mol)

If the measured formulated pH value is equal to or less than 3, then the value of the term “% NaOH_{Down}” is designated as being zero.

If the measured formulated pH value is less than 11, then a second titration step is required to determine the value of the term “% NaOH_{Up}”. A second 5 g sample of base composition is diluted with 45 g of DI water and then placed in an auto-titration machine. This time, the solution is adjusted with NaOH (0.1N) in 0.01 mL quantities until the measured solution pH is at least 11. The results from this second auto-titration series are used in the calculation below. The % RA contribution is determined by determining the % equivalent of NaOH which would be required in the solution in order to move the solution from the formulated pH value up to a pH of 11. (Note: The % RA contribution here is negative because it represents the NaOH that would need to be “removed” from the base solution in order to bring the pH down from 11 to the formulated pH.)

$$\% {NaOH}_{Up} = - \frac{mls NaOH * N . NaOH * 40 * 100}{Sample wt ( g ) * 1000}$$

wherein:

mls NaOH is the volume of NaOH added to achieve a pH of 11, in units of millilitres

N.NaOH is the concentration of the NaOH added, expressed in units of Normals

Sample wt (g) is the mass of the sample of undiluted base composition, in grams

“40” represents the molar mass of NaOH (in g/mol)

If the measured formulated pH value is equal to or greater than 11, then the value of the term “% NaOHa_{Up}” is designated as being zero.

The two steps above are combined to determine the amount of NaOH equivalent to move the solution from a pH of 3 to a pH of 11.

% RA=% NaOH_{Down}−% NaOH_{Up}

The RA value reported for the composition is the value that results from the calculation of % RA according to the simple subtraction equation provided above. The final RA value (% RA) is expressed as a percentage (%).

pH

Unless otherwise stated herein, the pH of a composition is defined as the pH of a 10% aqueous solution of the composition at 20±2° C. Any meter capable of measuring pH to ±0.01 pH units is suitable. Orion meters (Thermo Scientific, Clintinpark-Keppekouter, Ninovesteenweg 198, 9320 Erembodegem-Aalst, Belgium) or equivalent are acceptable instruments. The pH meter should be equipped with a suitable glass electrode with calomel or silver/silver chloride reference. An example includes Mettler DB 115. The electrode should be stored in the manufacturer's recommended electrolyte solution. The pH is measured according to the standard procedure of the pH meter manufacturer. Furthermore, the manufacturer's instructions to set up and calibrate the pH assembly should be followed.

### Viscosity

The viscosity is measured with a viscometer, such as the Brookfield RVD VII+, according to the manufacturer's instructions. Viscosity is measured at 21° C. using cup and bob geometry configuration in which Spindle #31 is rotated at 60 rpm to obtain an approximate shear rate of 20s⁻¹.

The liquid compositions (including liquid base compositions and/or liquid household care compositions) of the present disclosure may independently be characterized by a viscosity of from about 100 to about 2000 mPa*s, or from about 200 to about 1000 mPa*s, or from about 300 to about 800 mPa*s, at 21° C. and a shear rate of 20 s⁻¹. The compositions may independently have a viscosity of greater than 500 cps, measured at 21° C. and 20 s⁻1.

### EXAMPLES

The examples provided below are intended to be illustrative in nature and are not intended to be limiting.

### Example 1

### Production of Household Cleaning Compositions at Different pHs Using a Similar Base with Different Buffers

Product A is a low-surfactant composition at a low pH, made by combining sixty parts of Base 1 with fifteen parts of Buffer 1 (and twenty-five parts minors, solvents, and carriers). Product B is a low-surfactant composition at a traditional pH, made by combining sixty parts of Base 1 with ten parts of Buffer 2 (and thirty parts minors, solvents, and carriers).

Similar Base w/Different Buffers

| | Base 1 | Buffer 1 | Buffer 2 | Product A | Product B |
|---|---|---|---|---|---|
| Na-AES | 19.2% | | | 11.52% | 11.52% |
| Na-LAS | 4.8% | | | 2.88% | 2.88% |
| EtOH | 2.0% | | | 1.20% | 1.20% |
| PEI Polymer | 1.4% | | | 0.84% | 0.84% |
| Citric Acid | | 50% | 17% | 7.50% | 1.70% |
| Borax (5 mol) | | | 20% | | 2.00% |
| Sodium Hydroxide | | | 5% | | 0.50% |
| DTPA Chelant | | | | 0.50% | 0.50% |
| Enzyme | | | | 0.00% | 1.00% |
| Perfume | | | | 0.50% | 0.50% |
| Reserve Alkalinity | 0.31 | 25.4 | 19.25 | | |
| 10% pH | 11.4 | 1.9 | 7 | 2.8 | 8.7 |

### Example 2

### Production of Household Cleaning Compositions at Different pHs Using Different Base with Different Buffers

Product A is a low-pH composition that is rich in AES surfactant, made by combining sixty parts of Base 1 with fifteen parts of Buffer 1 (and twenty-five parts minors, solvents, and carriers). Product C is a LAS-rich composition at a traditional pH, made by combining fifty parts of Base 2 with ten parts of Buffer 2 (and forty parts minors, solvents, and carriers).

Different Base w/Different Buffers

| | Base | Base | Buffer | Buffer | Product | Product |
|---|---|---|---|---|---|---|
| | 1 | 2 | 1 | 2 | A | C |
| Na-AES | 19.2% | 3.0% | | | 11.52% | 1.50% |
| Na-LAS | 4.8% | 24.0% | | | 2.88% | 12.00% |
| EtOH | 2.0% | 2.0% | | | 1.20% | 1.00% |
| PEI Polymer | 1.4% | | | | 0.84% | 0.00% |
| Na-CS | | 3% | | | 0.00% | 1.50% |
| Citric Acid | | | 50% | 17% | 7.50% | 1.70% |
| Borax (5 mol) | | | | 20% | | 2.00% |
| Sodium | | | | 5% | | 0.50% |
| Hydroxide | | | | | | |
| DTPA Chelant | | | | | 0.50% | 0.50% |
| Enzyme | | | | | 0.00% | 1.00% |
| Perfume | | | | | 0.50% | 0.50% |
| Reserve | 0.31 | 2.0 | 25.4 | 19.25 | | |
| Alkalinity | | | | | | |
| 10% pH | 11.4 | 11.6 | 1.9 | 7 | 2.8 | 8.6 |

### Example 3

### Production of Household Cleaning Solutions at Different pHs Using Multiple Bases with Multiple Buffers

Products D and E are formulated at similar (traditional) pHs; both include boric acid buffer, and Product E further includes fatty acids. Product D is made by combining twenty parts of Base 1, thirty parts Base 3, and ten parts Buffer 2 (and forty parts minors, solvents, and carriers). Product E is made by combining twenty-five parts Base 1, twenty-five parts Base 3, five parts Buffer 2, and fifteen parts Buffer 3 (and thirty parts minors, solvents, and carriers).

Mixture of Bases w/Multiple Buffers

| | Base | Base | Buffer | Buffer | Product | Product |
|---|---|---|---|---|---|---|
| | 1 | 3 | 2 | 3 | D | E |
| Na-AES | 19.2% | 0.0% | | 12% | 3.84% | 6.60% |
| Na-LAS | 4.8% | 30.0% | | 3% | 9.96% | 9.15% |
| EtOH | 2.0% | 2.0% | | 3% | 1.00% | 1.45% |
| PEI Polymer | 1.4% | | | 1% | 0.28% | 0.50% |
| Nonionic | | 20.0% | | 0% | 6.00% | 5.00% |
| Surfactant | | | | | | |
| Propylene Diol | | 11.0% | | 8% | 3.30% | 3.95% |
| Distilled Fatty | | | | 15% | 0.00% | 2.25% |
| Acid | | | | | | |
| Na-CS | | 3% | | 1% | 0.90% | 0.90% |
| Citric Acid | | | 17% | | 1.70% | 0.85% |
| Borax (5 mol) | | | 20% | | 2.00% | 1.00% |
| Sodium | | 5% | 5% | 3% | 0.50% | 0.25% |
| Hydroxide | | | | | | |
| DTPA Chelant | | | | | 0.50% | 0.50% |
| Enzyme | | | | | 1.00% | 1.00% |
| Perfume | | | | | 0.50% | 0.50% |
| Reserve | 0.31 | 0.25 | 19.25 | 2.87 | | |
| Alkalinity | | | | | | |
| 10% dH | 11.4 | 11.6 | 7 | 8.4 | 8.6 | 8.7 |

### Example 4

### Exemplary Combinations

Table 4 below shows illustrative, non-limiting combinations of liquid base compositions and pH-adjusting materials that may be used in the presently described processes. Although the examples below are not necessarily tied to particular formulations or amounts, Table 4 conceptually shows a portion of the variety of combinations contemplated in the present disclosure. In Table 4, an “X” indicates that the material was added as part of the given combination.

TABLE 4

| | Combina- | Liquid | Liquid | Liquid | pH- | pH- |
|---|---|---|---|---|---|---|
| Example | tion | Base 1 | Base 2 | Base 3 | adj. 1 | adj. 2 |
| A | 1 | X | | | X | |
| | 2 | X | | | | X |
| B | 1 | X | | | X | |
| | 2 | | X | | X | |
| C | 1 | X | | | X | |
| | 2 | | X | | | X |
| D | 1 | X | | | X | |
| | 2 | X | | | X | |
| E | 1 | X | | | X | |
| | 2 | | X | X | X | X |
| F | 1 | X | | X | X | |
| | 2 | | X | | | X |
| G | 1 | X | X | | X | |
| | 2 | X | X | | | X |
| H | 1 | X | X | | X | |
| | 2 | X | X | X | | X |
| I | 1 | X | | | X | |
| | 2 | X | | X | | X |
| J | 1 | X | | | X | |
| | 2 | | X | | X | |
| | 3 | | X | X | | X |

The products resulting from the inputs above may be further differentiated by the additional adjuncts added, the pH-adjusting materials used, additional liquid base compositions used, and the ratios in which the base compositions are combined with the pH-adjusting materials, adjuncts, and/or each other.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for manufacturing a plurality of liquid household care compositions, the process comprising the steps of:
a. providing a first input material to a manufacturing system, the first input material comprising a first liquid base composition,
the first liquid base composition comprising from about 1% to about 75%, by weight of the first liquid base composition, of a surfactant system,
the first liquid base further being characterized by a Reserve Alkalinity of about 2.5% or less;
b. combining the first input material with a first pH-adjusting material to provide a first household care composition;
c. providing a second input material to the manufacturing system, the second input material comprising the first liquid base composition, a second liquid base composition, or mixtures thereof,
the second liquid base composition comprising from about 1% to about 75%, by weight of the second liquid base composition, of a surfactant system,
the second liquid base further being characterized by a Reserve Alkalinity of about 2.5% or less;
d. combining the second input material with the first pH-adjusting material, a second pH-adjusting material, or combinations thereof to provide a second household care composition,
wherein the combination of steps a and b is not identical to the combination of steps c and d.

2. A process according to claim 1, wherein the second input material comprises the first liquid base composition.

3. A process according to claim 1, wherein the second input material comprises the second liquid base composition.

4. A process according to claim 1, wherein the manufacturing system comprises a closed central pipe, a batch tank, a conveyor system, or combinations thereof.

5. A process according to claim 1, wherein the first input material is provided to a first container on the manufacturing system, and wherein the second input material is provided to a second container on the manufacturing system.

6. A process according to claim 1, wherein the manufacturing system is flushed with a composition between the providing of the first input material and the providing of the second input material.

7. A process according to claim 1, wherein the surfactant systems of the first and second liquid base compositions each independently comprise a detersive surfactant comprising anionic surfactant, nonionic surfactant, zwitterionic surfactant, or mixtures thereof.

8. A process according to claim 7, wherein at least one of the following is true:
the anionic surfactant is selected from linear and/or branched alkoxylated alkyl sulfate, linear and/or branched alkyl benzene sulphonate, or mixtures thereof; and/or
the nonionic surfactant comprises ethoxylated alcohol; and/or
the zwitterionic surfactant comprises amine oxide.

9. A process according to claim 1, wherein at least one of the surfactant systems of the first and/or second liquid base compositions comprise anionic alkoxylated alkyl sulfate as a major surfactant component.

10. A process according to claim 1, wherein at least one of the surfactant systems of the first and/or second liquid base compositions comprise anionic alkyl benzene sulfonate as a major surfactant component.

11. A process according to claim 1, wherein the first and/or second liquid base compositions has a Reserve Alkalinity of from about 0.1% to about 2.25%.

12. A process according to claim 1, wherein the first pH-adjusting material and/or the second pH-adjusting material comprises a material independently selected from the group consisting of: a non-surfactant organic acids; a borate compound; a fatty acid; an alkanolamine; a caustic hydroxide compound; a carbonate; a zeolite; and mixtures thereof.

13. A process according to claim 1, wherein:
the first pH-adjusting material comprises a first buffering agent and is added to the first input material in an amount sufficient so that the first household care composition comprises from about 1% to about 25%, by weight of the first household care composition, of the first buffering agent; or
the second pH-adjusting material comprises a second buffering agent and is added to the second input material in an amount sufficient so that the second household care composition comprises from about 1% to about 25%, by weight of the second household care composition, of the second buffering agent; or both.

14. A process according to claim 1, wherein the first liquid base composition and/or the second liquid base composition is characterized by a pH of at least about 9.

15. A process according to claim 1, wherein the first household care composition is characterized by a first pH, and the second household care composition is characterized by a second pH that is different from the first pH.

16. A process according to claim 1, wherein:
the first household care composition is characterized by a first pH that is about 7.5 or greater; or
the second household care composition is characterized by a second pH that is about 6.5 or less; or
both.

17. A process according to claim 1, wherein the process further comprises at least one additional step of adding one or more adjuncts independently to the first input material, the second input material, or both.

18. A process according to claim 17, wherein the one or more adjuncts comprise a structurant, a builder, an organic polymeric compound, an enzyme, an enzyme stabilizer, a bleach system, a brightener, a hueing agent, a chelating agent, a suds suppressor, a conditioning agent, a humectant, neat perfume, perfume encapsulates, a filler or carrier, or mixtures thereof.

19. A process according to claim 1, wherein the first input material and/or the second input material further comprises a third liquid base composition, the third liquid base composition comprising from about 1% to about 75%, by weight of the second liquid base composition, of a surfactant system, the third liquid base composition further being characterized by a Reserve Alkalinity of up to about 2%, wherein the third liquid base composition is compositionally different from the first and second liquid base compositions.

20. A process according to claim 1, wherein the first and second household care compositions are independently selected from a laundry detergent composition, a fabric pretreatment composition, a fabric softener composition, a dish care composition, or a combination thereof.

21. A process according to claim 1, wherein the plurality of liquid household care compositions made from the process comprises at least three household care compositions for each liquid base composition used in the process.
